(19) United States
(12) Patent Application Publication
(10) Pub. No.: US 2004/0119825 A1
(43) Pub. Date: Jun. 24, 2004

(54) Video camera device having blue tooth internet communicating device

(76) Inventor: Mark Tung, Hsin Chuang City (TW)

Correspondence Address: Mark Tung, P.O. Box 4-67, Hsin Chuang, Taipei, 242, TW

(21) Appl. No.: 10/327,429

(22) Filed: Dec. 19, 2002

(51) Int. Cl. H04N 5/225

(52) U.S. Cl. 348/207.1

(57) ABSTRACT

A video camera device for coupling to computer facilities includes an interface device for coupling to the computer facilities, a camera module coupled to the interface device for obtaining and sending image signals to the computer facilities, and a blue tooth device coupled to the interface device. The blue tooth device includes an antenna for sending out and for receiving image signals, and for allowing users to easily and readily communicate the image signals with the other users via the antenna or via various network systems.

### BACKGROUND OF THE INVENTION

1. Field of the Invention

The present invention relates to a video camera, and more particularly to a video camera device having blue tooth internet communicating device for communicating with computer facilities via network systems or the like.

2. Description of the Prior Art

Typical blue tooth telecommunication devices or transmitting devices have been developed for sending or transmitting video images or signals to the other computers or receiver facilities, and for receiving the video images or signals from the other computers or receiver facilities.

The users have to purchase the digital video camera and the blue tooth telecommunication devices or transmitting devices, separately, by themselves, and to couple the video camera and the blue tooth transmitting devices or telecommunication devices to their computer facilities or the like, and the users then have to couple or communicate the video camera and the blue tooth telecommunication devices or transmitting devices with each other.

However, only some of the talented users and the experts may purchase and couple the digital video camera and the blue tooth telecommunication devices or transmitting devices to the computer facilities by themselves, and thus only few users may communicate with each other with the video camera and the blue tooth telecommunication devices or transmitting devices.

The present invention has arisen to mitigate and/or obviate the afore-described disadvantages of the conventional video cameras.

### SUMMARY OF THE INVENTION

The primary objective of the present invention is to provide a video camera device having a blue tooth internet communicating device for communicating with the other computer facilities with such as internet or network systems or via antenna devices.

In accordance with one aspect of the invention, there is provided a video camera device for coupling to computer facilities, the video camera device comprising an interface device for coupling to the computer facilities, a camera module coupled to the interface device for obtaining image signals, and for sending the image signals to the computer facilities, and a blue tooth device coupled to the interface device, and including an antenna for sending out the image signals, and for receiving image signals. The users may thus easily and readily receive image signals or send image signals to the other users via the antenna or the other network systems.

The interface device includes a coupler for coupling to the computer facilities, and includes an interface switching device coupled between the camera module and the blue tooth device.

The camera module includes a USB interface member coupled to the interface device, and a power supply circuit coupled to the USB interface member. The camera module includes an image detector device for obtaining the image signals. The camera module further includes an image processing circuit coupled to the image detector device for processing the image signals from the image detector device.

The camera module further includes a signal converting circuit coupled to the image processing circuit to receive and convert the image signals form the image processing circuit, and to send the image signals to the interface device.

The blue tooth device includes a USB interface member coupled to the interface device, and a power supply circuit coupled to the USB interface member.

The blue tooth device includes a blue tooth chip for processing signals from the interface device, and includes a converting circuit coupled to the blue tooth chip to receive and convert the signals form the blue tooth chip. The antenna is coupled to the converting circuit for receiving or sending signals to and from the converting circuit.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plan schematic view of a video camera device having blue tooth internet communicating device in accordance with the present invention;

FIG. 2 is a block diagram illustrating the elements or members of the blue tooth internet communicating device for the video camera device;

FIG. 3 is a block diagram illustrating the communication between the users with the video camera device having the blue tooth internet communicating device built therein or coupled thereto; and

FIG. 4 is a block diagram illustrating the communication between the blue tooth internet communicating device and the video camera device.

### DETAILED DESCRIPTION OF THE PREFERRED EMBODIMENT

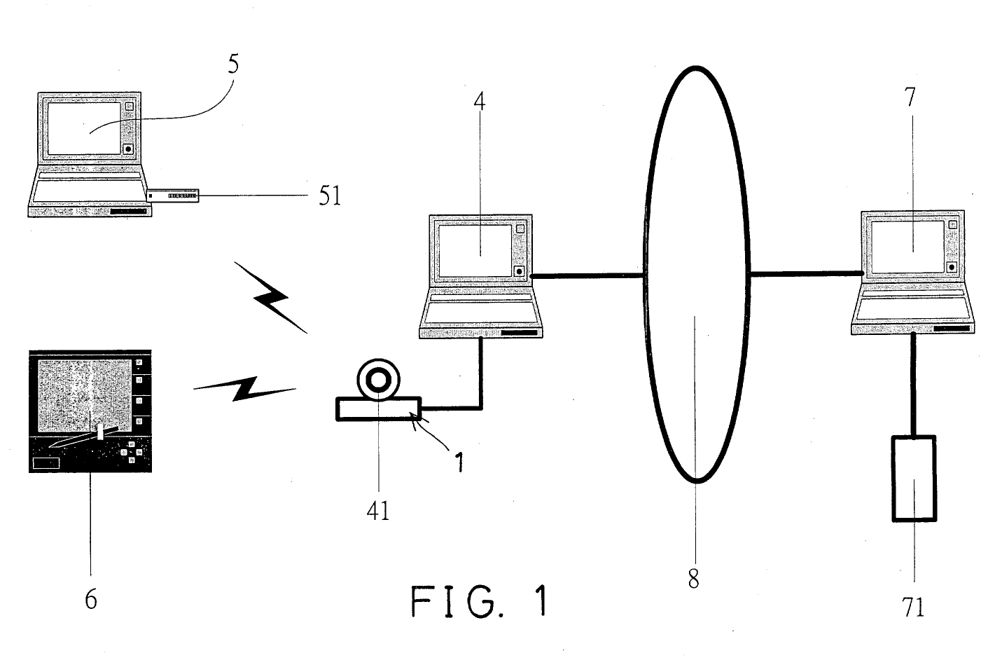

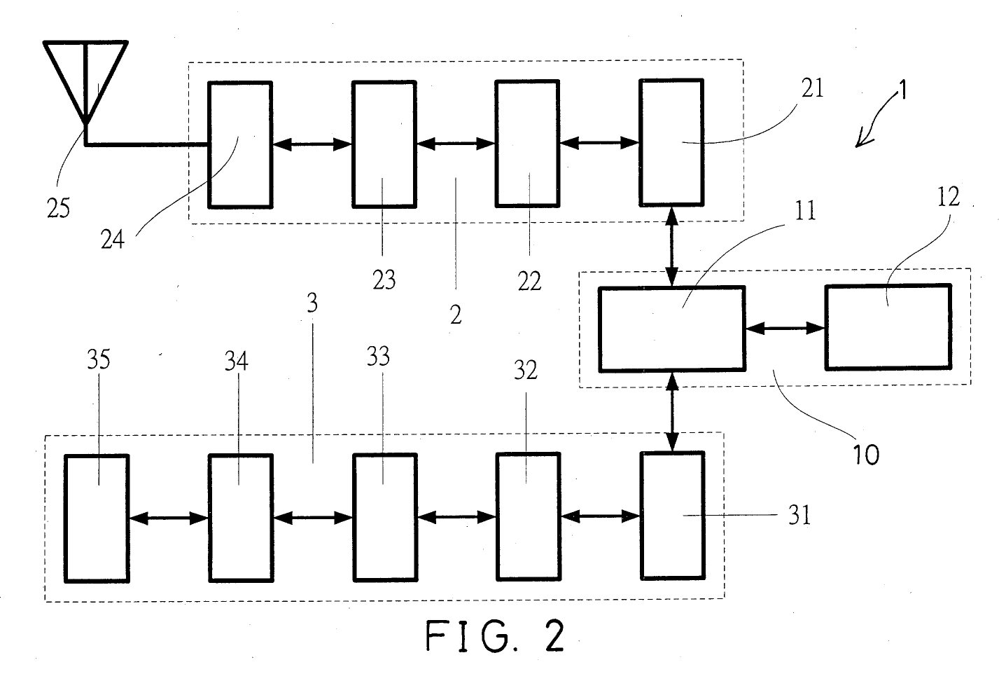

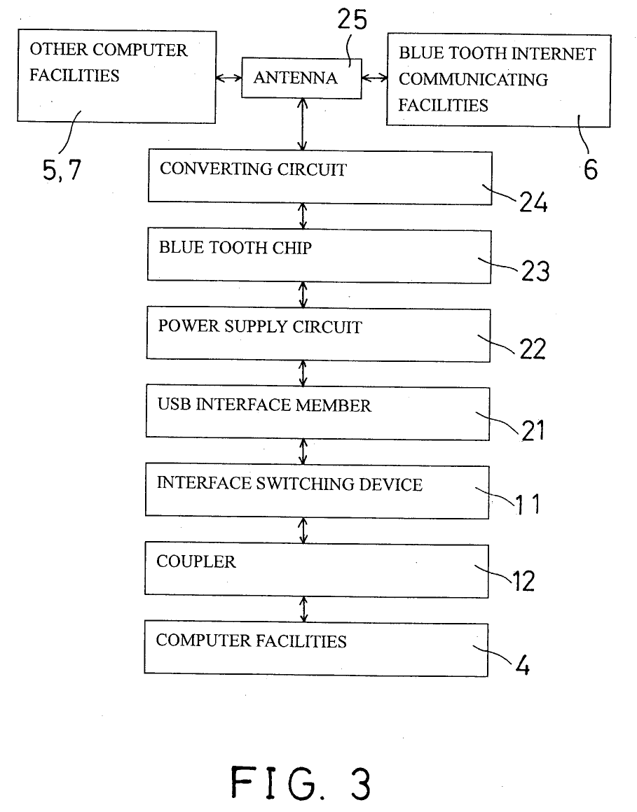

Referring to the drawings, and initially to FIG. 1, a video camera device in accordance with the present invention is generally indicated with a reference numeral “41”, and comprises a blue tooth internet communicating device 1 built therein, or coupled thereto, for coupling to computer facilities 4, and for coupling to or communicating with the other computer facilities 5, 7 or blue tooth internet communicating facilities 6 (FIGS. 1, 3) with such as internet or network systems 8, or via antenna devices 25 (FIGS. 2, 3).

As shown in FIGS. 2 and 3, the blue tooth internet communicating device 1 for the video camera device 41 includes an interface module or device 10 having an interface switching device 11, and a coupler 12, such as a universal serial bus (USB) coupler 12 coupled to the interface switching device 11, for plugging or coupling to the computer facility 4 or the like, and for communicating the interface switching device 11 with the computer facility 4.

The interface switching device 11 is plugged to or coupled to a blue tooth module or device 2, and to a camera module 3, for coupling or communicating either or both the blue tooth device 2 and the camera module 3 to the computer facility 4 with or via the coupler 12, and thus for allowing either or both the blue tooth device 2 and the camera module 3 to receive signals from or to send signals to the computer facility 4.

For example, the blue tooth device 2 includes a USB interface member 21, a power supply circuit 22, a blue tooth integrated circuit or chip 23, a converting circuit 24, and an antenna 25 coupled together, and coupled in series to the interface switching device 11. The USB interface member 21 is provided for coupling or communicating or transmitting signals between the blue tooth device 2 and the interface switching device 11.

The power supply circuit 22 may be connected to the electric power source of the computer facility 4 via the USB interface member 21, for receiving the electric power from such as the computer facility 4, and thus for supplying electric power to energize the blue tooth device 2. The blue tooth integrated circuit or chip 23 is provided for treating or processing the signals to or from or between the converting circuit 24 and the computer facility 4 or from the interface device 10.

For example, the blue tooth integrated circuit or chip 23 may receive and treat or process the signals from the converting circuit 24 and the antenna 25, and then send the signals to the computer facility 4; or may receive and treat or process the signals from the computer facility 4, and then send the signals to the converting circuit 24, and then send out the signals via the antenna 25. The blue tooth integrated circuit or chip 23 may be arranged or changed or converted into various wireless communicating schedules or requirements, such as 802.11b, 802.11a, 802.11g, etc.

The converting circuit 24 may convert the signals from the antenna 25, and then may send the converted signals to the blue tooth integrated circuit or chip 23, and then to the computer facilities 4; or may convert the signals from the blue tooth integrated circuit or chip 23, for allowing the signals to be sent to the other computer facilities 5, 7 or to the other blue tooth internet communicating facilities 6 with the internet or network systems 8, or via antenna devices 25.

Accordingly, the video camera device 41 that is coupled to the computer facilities 4 includes the blue tooth internet communicating device 1 built therein, or coupled thereto, for coupling to or communicating with the blue tooth internet communicating devices 51, 71 of the other computer facilities 5, 7, or for directly communicating with the other blue tooth internet communicating facilities 6 with the internet or network systems 8, or via antenna devices 25.

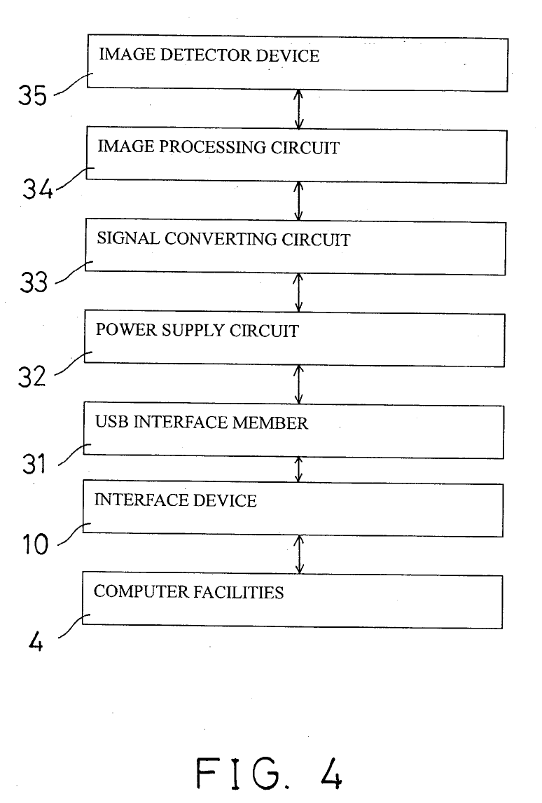

As shown in FIGS. 2 and 4, the camera module 3 of the blue tooth internet communicating device 1 for the video camera device 41 includes a USB interface member 31, a power supply circuit 32, a signal converting circuit 33, an image processing circuit 34, and an image detector device 35 coupled together, and coupled in series to the interface switching device 11 of the interface device 10.

The USB interface member 31 is provided for coupling or communicating or transmitting signals between the camera module 3 and the interface switching device 11 of the interface device 10. The power supply circuit 32 may be connected to the electric power source of the computer facility 4 via the USB interface member 21, for receiving the electric power from such as the computer facility 4, and thus for supplying electric power to energize the camera module 3.

The image detector device 35 is provided for actuating or controlling the camera module 3 to detect, or to film, or to tape or record or grab video signals or images, which may then be sent to the image processing circuit 34. The image processing circuit 34 may then treat or process the video images or signals from the image detector device 35, and then send the video signals or images to the signal converting circuit 33.

The signal converting circuit 33 may thus receive and treat or process or convert the video signals from the image processing circuit 34, and then send the signals to the computer facility 4, for allowing the computer facility 4 to easily and readily receive or obtain the signals or images from the signal converting circuit 33 and the image processing circuit 34, and the image detector device 35.

In operation, as shown in FIG. 1, the computer facility 4 of the user may easily and readily grab or receive or obtain the signals or images from the signal converting circuit 33 and the image processing circuit 34, and the image detector device 35 of the camera module 3, and may easily and readily use the blue tooth internet communicating device 1 thereof to communicate with the other computer facilities 5, 7 or blue tooth internet communicating facilities 6 with such as internet or network systems 8, or via antenna devices 25 (FIGS. 2, 3).

Accordingly, the video camera device includes a blue tooth internet communicating device in accordance with the present invention for easily and readily communicating with the other computer facilities with such as internet or network systems or via antenna devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A video camera device for coupling to computer facilities, said video camera device comprising:
an interface device for coupling to the computer facilities,
a camera module coupled to said interface device for obtaining image signals, and for sending the image signals to the computer facilities, and
a blue tooth device coupled to said interface device, and including an antenna for sending out the image signals, and for receiving image signals.

2. The video camera device according to claim 1, wherein said interface device includes a coupler for coupling to the computer facilities, and includes an interface switching device coupled between said camera module and said blue tooth device.

3. The video camera device according to claim 1, wherein said camera module includes a USB interface member coupled to said interface device, and a power supply circuit coupled to said USB interface member.

4. The video camera device according to claim 1, wherein said camera module includes an image detector device for obtaining the image signals.

5. The video camera device according to claim 4, wherein said camera module further includes an image processing circuit coupled to said image detector device for processing the image signals from said image detector device.

6. The video camera device according to claim 5, wherein said camera module further includes a signal converting circuit coupled to said image processing circuit to receive and convert the image signals form said image processing circuit, and to send the image signals to said interface device.

7. The video camera device according to claim 1, wherein said blue tooth device includes a USB interface member coupled to said interface device, and a power supply circuit coupled to said USB interface member.

8. The video camera device according to claim 1, wherein said blue tooth device includes a blue tooth chip for processing signals from said interface device.

9. The video camera device according to claim 8, wherein said blue tooth device further includes a converting circuit coupled to said blue tooth chip to receive and convert the signals form said blue tooth chip.

10. The video camera device according to claim 9, wherein said antenna is coupled to said converting circuit for receiving or sending signals to and from said converting circuit.
